(19) United States
(12) Patent Application Publication
(10) Pub. No.: US 2012/0175358 A1
(43) Pub. Date: Jul. 12, 2012

(54) Oil pan drain plug heater

(76) Inventor: Marvin Lee Davidson, JR., Greenbrier, TN (US)

(21) Appl. No.: 12/930,455

(22) Filed: Jan. 7, 2011

(51) Int. Cl. B60L 1/02

(52) U.S. Cl. 219/202

(57) ABSTRACT

An internal combustion engine having an oil or transmission pan with a removable drain plug bolt and threaded opening or any type of tank or reservoir, containing a liquid to be heated, which utilizes a bolt and threaded opening as a drain site. An apparatus consisting of a machined heater body containing a heating element, a temperature sensor, and power cord. This apparatus, when installed in said opening and energized, heats oil in an oil pan, transmission fluid in a transmission pan, or any type of tank or reservoir containing a liquid to be heated.

### CROSS REFERENCE TO RELATED APPLICATIONS

Not applicable

### STATEMENT REGARDING FEDERALLY SPONSORED RESEARCH

Not applicable

### REFERENCE TO SEQUENCE LISTING

Not applicable

### FIELD OF THE INVENTION

The oil pan drain plug heater pertains to the improvements gained by vehicles, equipment, and machinery that exist and operate in cold weather. The internal combustion engine, having an oil or transmission pan containing an amount of oil or transmission fluid, or any type of tank or reservoir, of similar size, containing a liquid to be heated, requires oils and liquids to remain at a specific temperature range especially under cold weather conditions. Where as the engine oil or transmission fluid is pre-heated to: extend engine or transmission life under such conditions, to aid in cold weather starts, and to increase operating efficiency. The oil pan drain plug heater offers improvements to other types of machines, tanks, and reservoirs that exist in a cold weather environment, where the oil or liquids contained must remain above the relative temperature, provided, like the oil and transmission pan, they utilize drain plug bolts for draining purposes.

### BACKGROUND OF THE INVENTION

Internal combustion engines under cold weather conditions utilize certain types of heaters to heat certain types of liquids and oils contained in the engine. The oil pan drain plug heater pertains to the heating of oil or transmission fluid in an engine's oil or transmission pan, or any type of tank or reservoir, that utilizes a drain plug bolt, containing a liquid to be heated. A oil pan drain plug heater is to aid in overall engine or transmission life, efficiency, and cold weather starts. In application a permanent or semi-permanent installation of a engine, tank, or reservoir heater is desired. This desire is realized through location of the installation. The oil pan drain plug heater is installed in the drain plug threaded opening. In operation an immersion type engine oil heater must remain completely submerged in the oil of the oil pan or liquid of a tank or reservoir, or the heater will burn out in the air. An installation site such as the drain plug is ideal for the oil pan drain plug heater to stay completely submerged in the liquid, where as drain plugs are located at the lowest point of a reservoir or pan. Other types of machinery, tanks, and reservoirs typically locate a drain plug site at the lowest point and utilize a drain plug bolt. Engine oil changes are part of routine maintenance, the present invention could be installed or removed easily at that time. Considering ease of installation and functionality, the present invention embodies the more desirable characteristics of an immersion type internal combustion engine heater. The most significant improvement is to contain a heating element in a heater body that also functions as a drain plug, in order to utilize the drain site as the optimum installation location.

### SUMMARY OF THE INVENTION

An oil pan drain plug heater suited to use in an internal combustion engine having an oil or transmission pan, or any type of tank or reservoir, containing a liquid to be heated, which utilizes a bolt and threaded opening as a drain site. The oil pan drain plug heater installed in place of the tank's, reservoir's, or engine oil or transmission pan's, drain plug. The oil pan drain plug heater, while connected to a power supply, will energize a circuit containing a temperature sensor and resistance wire as used in heating elements. The temperature sensor limits the current energizing the circuit in a manner as to limit the maximum temperature and more accurately maintain a predetermined constant temperature. Thus heating, in a controlled manner, the oil or transmission fluid in an engine's oil or transmission pan, or a liquid to be heated contained in a tank or reservoir, which utilizes a bolt and threaded opening as a drain site.

### BRIEF DESCRIPTION OF THE DRAWINGS

FIG. 1 shows a side view of an oil pan drain plug heater.

FIG. 2 shows a front view of an oil pan drain plug heater.

FIG. 3 shows a rear view of an oil pan drain plug heater.

FIG. 4 shows a cross section view of an oil pan drain plug heater.

FIG. 5 shows a cross section view of an oil pan drain plug heater with the temperature sensor housed in the power cord.

FIG. 6 shows a cross section view of an oil pan drain plug heater that has an external housing to contain the temperature sensor.

FIG. 7 shows a cross section view of an oil pan with an oil pan drain plug heater installed in place of the oil pan drain plug.

### DETAILED DESCRIPTION OF THE DRAWINGS

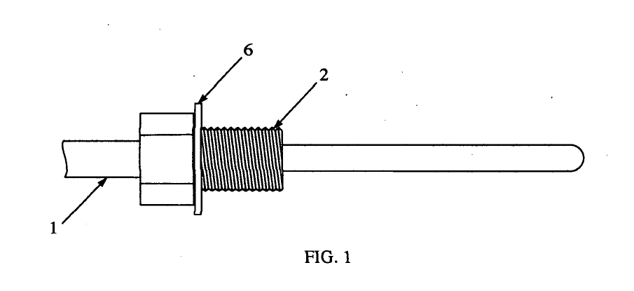

Referencing FIG. 1, a side view of an oil pan drain plug heater. The heater body, 2, is machined to have a head that secures against a washer, 6, which is tightened to an engine's oil or transmission pan, or a tank or reservoir's body. Threads are machined to match the removable drain plug or threaded opening of an engine's oil or transmission pan, tank, or reservoir. The heater body, 2, is machined to have an area to house a heating element. The power cord, 1, is connected to the heater body, 2, through the head of the body.

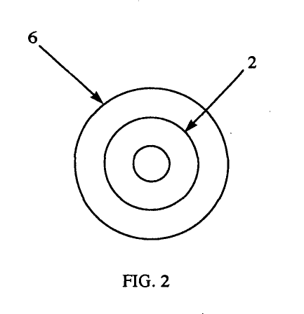

Referencing FIG. 2, a front view of an oil pan drain plug heater. The heater body, 2, is made so that the heating element portion is smaller, in diameter, than the threaded portion. The washer, 6, also seen is this view, is larger, in diameter, than the heater body, 2.

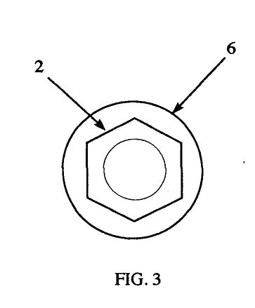

Referencing FIG. 3, a rear view of an oil pan drain plug heater. The heater body, 2, is machined typically to have a hex head to adapt to existing installation tools or to have a specialty head to be installed by means of specialty installation tools. The washer, 6, can be seen in this view behind the head of the heater body, 2.

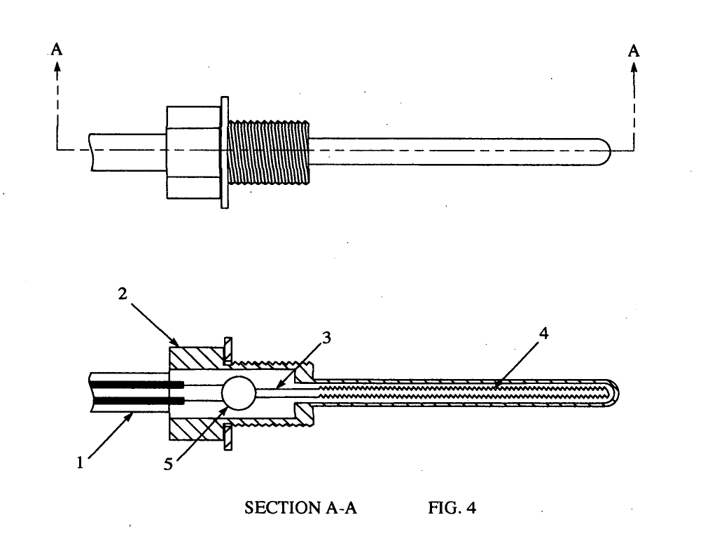

Referencing FIG. 4, a cross section view of an oil pan drain plug heater. The heater body, 2, is machined to have an area to house a heating element, 4, to be insulated, inside the heater body. In this view the temperature sensor, 5, is seen as an internal part of the heater body, 2. The heater body will be machined to include an area to house electrical connecters, 3. The oil pan drain plug heater will have an electrical cord, 1, connecting to a temperature sensor, 5, through the head of the heater body, 2, connecting to the heater element, 4.

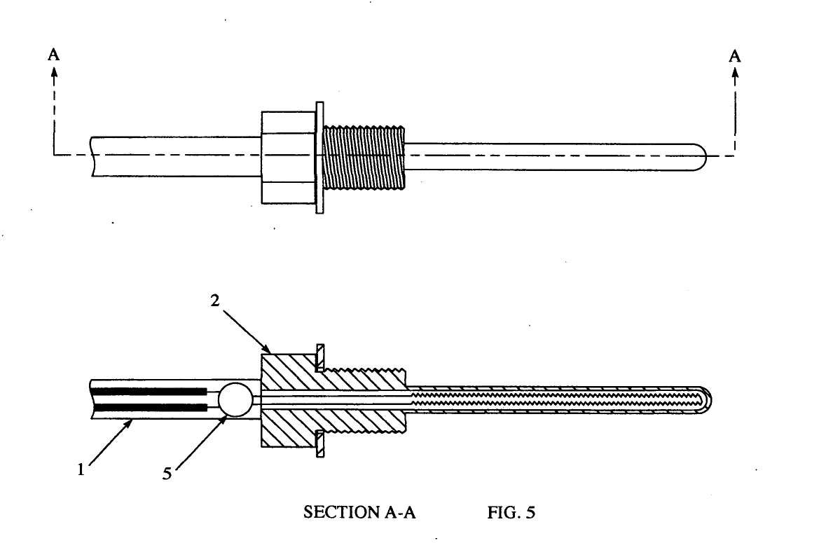

Referencing FIG. 5, a cross section view of an oil pan drain plug heater. In this view the temperature sensor, 5, is seen as an external part of the heater body, 2. The temperature sensor, 5, is incorporated into the power cord, 1. The temperature sensor, 5, may be located in the power cord, 1, for various reasons: in certain applications the heater body, 2, may be too small to accommodate the temperature sensor, cost to produce, manufacturing equipment, fabricating techniques, or ease of installation could be a factor. The temperature sensor, 5, located in the power cord, 1, will allow for less machining to the heater body, 2, but will require more fabrication to the power cord, 1.

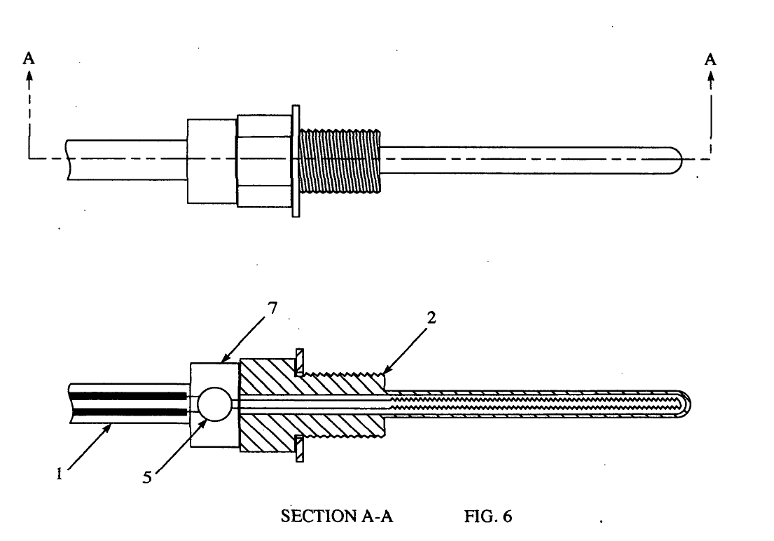

Referencing FIG. 6, a cross section view of an oil pan drain plug heater. In this view the temperature sensor, 5, is seen as an external part of the heater body, 2. An external housing, 7, is used to contain the temperature sensor, 5. An external housing, 7, may be used to house the temperature sensor, 5, also for various reasons: to accommodate a temperature sensor, 5, if the heater body, 2, is to small for the sensor, 5, cost to produce, manufacturing equipment, fabricating techniques, and ease of installation could all be considered when desiring to locate the temperature sensor, 5, externally in a housing.

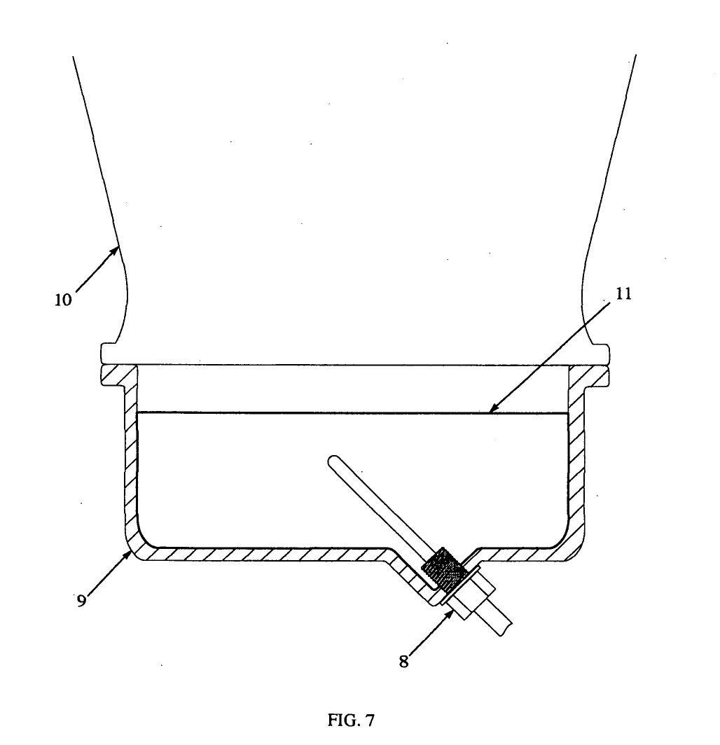

Referencing FIG. 7, a side view of an oil pan drain plug heater, 8, installed in, as seen here, a cross section of an oil pan, 9. The oil pan, 9, is seen attached to an engine block, 10, as it functions as an oil, 11, reservoir. In this view it is easy to see that the installation location is ideal for the oil pan drain plug heater, 8, to stay submerged in the oil, 11, of the oil pan, 9.

1. An oil pan drain plug heater suited, but not limited to, use in an internal combustion engine having an oil or transmission pan used to contain an amount of oil or transmission fluid, or any type of tank or reservoir, containing a liquid to be heated, which utilizes a removable drain plug bolt for draining purposes. The oil pan drain plug heater comprising of: a heater body threaded to match the removable drain plug and threaded opening, a heating element to remain submerged in the liquid to be heated, electrical connectors and power cord to energize the heating element, a temperature sensor to limit the flow of current to the heating element, a washer to prevent any leaks, is installed in the treaded opening from where the drain plug bolt is removed. The power cord, connected to an outlet, energizes the heater circuit, controlled by the temperature sensor, and heats the engine's oil in the oil pan, transmission fluid in the transmission pan, or a liquid to be heated in a tank or reservoir.

2. The heater body of claim 1, to be one piece or consisting of more than one piece mechanically or chemically bonded as one piece.

3. The heater body of claim 1, threaded to match a removable drain plug or threaded opening.

4. The heater body of claim 1, machined to adapt to existing installation tools or to be installed by means of specialty installation tools.

5. The heater body of claim 1, to internally house resistance wire and insulation as used in heating elements and electrical connectors used in connecting resistance wire and power wire.

6. The heater body of claim 1, to internally or externally contain electrical connectors used in connecting resistance wire and power wire.

9. The heater body of claim 1, to internally or externally contain a temperature sensor regulating current to the heating element in response to temperature.

10. The drain plug oil heater of claim 1, to utilize the drain plug drain site as the installation site.

11. The power cord of claim 1, may be fabricated to contain the temperature sensor and electrical connectors.

12. The temperature sensor of claim 1, may be housed in the heater body, the power cord, or a separate housing that connects to the power cord and heater body.
